(19) United States
(12) Patent Application Publication
(10) Pub. No.: US 2020/0130258 A1
(43) Pub. Date: Apr. 30, 2020

(54) METHOD AND DEVICE FOR PRODUCING A PAVING AREA

(71) Applicant: PRINTSTONES GMBH, Wien (AT)

(72) Inventors: Herwig HENGL, Vienna (AT); Hueseyin KESKIN, Vienna (AT); Markus BRENNER, Vienna (AT)

(21) Appl. No.: 16/620,471

(22) PCT Filed: Feb. 12, 2018
(86) PCT No.: PCT/AT2018/060038

§ 371 Date: Dec. 6, 2019

(30) Foreign Application Priority Data
Jun. 6, 2017 (AT) A 60046/2017

(51) Int. Cl. B29C 64/106; B28B 1/00; B29C 64/20; E01C 19/48

(52) U.S. Cl. CPC B29C 64/106; B28B 1/001; B33Y 10/00; E01C 19/48; B29C 64/20

(57) ABSTRACT

The invention relates to a method and a device for producing a paving area from paving elements, wherein the paving elements are printed in situ from a printable material onto a surface in a 3D printing method using a 3D printing device.

The invention pertains to a method for producing a paving area from paving elements, particularly from paving stones or paving slabs.

The invention also pertains to a device for producing a paving area from paving elements, particularly from paving stones or paving slabs.

Paving elements are parts of a pavement or pavement surface, i.e. a surface for traffic areas in the construction of roads and paths. In the prior art, the paving elements lie in a pavement bedding. At least one bearing layer, which usually consists of compacted broken stone or concrete, is located underneath said pavement bedding. Paving stones are usually manufactured from natural stone, concrete, clinker, wood or blast furnace slag.

It is known to install paving stones of concrete or natural stone manually. It is also known to realize a mechanized installation as an alternative to the manual installation. The paving area is typically installed on a specially prepared subsurface, namely the bedding. Compacted bearing layers and anti-frost layers are usually located underneath this bedding. The bedding is typically produced from mortar, stone chips or sand. Gaps are usually formed between the individual paving stones in the installed state, wherein said gaps can be filled, for example, with sand or mortar. Until now, paving stones are either struck, cut or nipped from natural stone or cast in molds from concrete, mortar or another casting material and cured.

A method for installing paving stones is known, for example, from WO 95/14821 A1. This method utilizes an installation apparatus that comprises a gripper with a pair of gripper jaws. Stones made available in layers can be grasped along their edges with a gripping motion, lifted, as well as transported to and deposited at an installation site, by means of this installation apparatus.

The known methods for installing paving stones disadvantageously require the use of a significant workforce. In addition, individual paving stones frequently have to be cut to size on the edges of the paving area, wherein this leads to unnecessary material consumption, as well as fine dust pollution. Furthermore, the paving stones of a paving area have to be carefully installed in order to ensure a uniform height of the area. Uniform gap spacing also has to be observed. In addition, the paving stones are manufactured in a corresponding facility, transported to a storage area or depot at the construction site and then delivered to the installation site. The stones ultimately have to be installed manually or in a mechanized manner. However, this sequence requires considerable logistical effort that significantly increases the costs.

Consequently, the present invention is based on the objective of eliminating or at least mitigating at least individual disadvantages of the prior art. The invention therefore particularly aims to develop a method and a device of the initially cited type, by means of which the production of an individually designed paving area is simplified.

This objective is attained by means of a method with the characteristics of claim 1 and by means of a device with the characteristics of claim 16. Preferred embodiments are specified in the dependent claims.

According to the invention, the paving elements are printed onto a surface in situ from a printable material in a 3D printing process using a 3D printing device.

Consequently, the individual paving elements are advantageously produced on the surface to be printed in situ by means of the 3D printing process (i.e. an additive process) in order to produce the paving area on the surface. A traffic area or path area can thereby be created. According to the invention, the geometric shape of the paving elements can be directly and immediately defined or modified in situ. The shape of the paving elements can furthermore be adapted to boundary conditions such as the dimensions of the surface to be printed, installations and edgings. Each paving element therefore can be adapted to individual shape specifications without having to cut the paving element to the required size/shape. The 3D printing process can be carried out by using a 3D printing device that is realized, for example, as a robot in particular displaceable horizontally and/or vertically or a stationary robot or a preferably displaceable production bridge. The 3D printing device to be used is delivered to the construction site, at which the paving area should be produced. The 3D printing device is then correspondingly positioned at the construction site and begins with the additive production (“3D printing”) of the paving elements. The paving elements therefore are not manufactured beforehand in a corresponding facility, but rather directly produced or printed in situ, i.e. at the intended installation site of the paving area. Depending on its design, the 3D printing device may furthermore be used for producing a bedding, preferably from at least one material of the group consisting of sand, stone chips or bedding mortar.

For the purposes of this disclosure, the term “paving stone” refers to a paving element, the maximum overall length (horizontal extent) of which does not exceed 30 cm and the minimum thickness (vertical extent) of which is greater than one-third of the maximum overall length.

For the purposes of this disclosure, the term “paving slab” refers to a paving element, the maximum overall length of which is greater than 15 cm and does not exceed 1 m and the maximum thickness of which amounts to no more than one-third of the maximum overall length.

For the purposes of this disclosure, location and direction information such as “top,” “bottom,” etc. refers to the finished paving area at the installation site.

In a preferred embodiment, the 3D printing device is supplied with a dry material that is mixed with water in the 3D printing device and subsequently printed. The 3D printing device particularly may be supplied with different materials in their dry state. The 3D printing device may alternatively receive the printable material in a liquid state.

Among other things, the 3D printing device may be supplied with a printable material that comprises at least one of the materials wet concrete, dry concrete, cement, wet mortar, dry mortar, concrete additive, screed, aggregate stone, sand, binder, lime, clay, gypsum, silicone, wood particles, ceramic, different natural stones, brick, water, adhesive, plastic, plaster, graphene, metal such as steel or aluminum, synthetic materials, insulating materials, sealing materials, glass and asphalt. The 3D printing device may also be supplied with mixtures of these materials. Consequently, these materials may also form a component of the paving elements produced by means of the 3D printing device.

In a preferred embodiment, the 3D printing device comprises an extruder, by means of which the printable material is applied onto a surface. The components of the printable material preferably are mixed with one another within the extruder, directly upstream of the extruder, in a mixing chamber or in a static mixer and subsequently applied onto the surface to be printed.

In a preferred embodiment, a bedding layer, particularly from a material that is selected from the group consisting of stone chips, sand or mortar, onto which the printable material is printed, is produced with the 3D printing device. In this way, not only the paving area, but also the bedding layer, can be advantageously produced by means of the 3D printing device such that the production method is simplified and the mechanization effort is reduced. The surface to be printed with the paving area therefore may preferably be a bedding layer that is produced from at least one of the materials stone chips, sand or bedding mortar.

The paving elements preferably are produced comprising at least one first layer and one second layer of the printable material. Since the paving elements are composed of multiple layers that preferably extend essentially horizontally, it is possible to use different materials in different layers or even within one layer of the paving elements. Decorative effects, but also technical effects, can thereby be realized. For example, a cold and/or moisture insulation layer that particularly consists of foamed synthetic materials such as EPS, XPS or foamed elastomers or of other fibers or foams, which are optionally bound by cement, may be incorporated into the paving element. Furthermore, the use of different materials makes it possible to produce composite materials.

In order to produce multiple paving elements with a layered structure simultaneously, it may be advantageous to initially produce the first layers of the paving elements prior to the production of the second layers of the paving elements. Multiple paving elements with a certain shape can thereby be produced step-by-step, wherein the production begins with a first paving element, i.e. the first layer of the first paving element is produced, subsequently a second paving element is started, i.e. the first layer of the second paving element is produced, and then optionally a third and additional paving elements are started, whereupon the production of the first paving element, the second paving element, etc. is continued. This process is repeated until all paving elements, which are therefore essentially produced simultaneously, are completed.

In a preferred embodiment, the (horizontal) cover layers of the paving elements, i.e. the visible sides, are printed with a higher resolution than the (horizontal) subjacent layers of the paving elements.

In a preferred embodiment, the paving elements are printed with an internal structure containing hollow spaces. This embodiment has the advantage that the weight of the paving elements can be reduced.

In this embodiment, it is advantageous to print the internal structure onto at least one full-surface bottom layer of the respective paving element. The cover layers can ultimately be printed onto the internal structures such that internal structures are closed at the top and at the bottom.

In a preferred embodiment, the production of the paving element therefore comprises the following steps:
preferably printing at least one full-surface bottom layer;
printing the contour of the paving element;
printing an internal structure within the contour of the paving element, wherein the internal structure contains hollow spaces, or completely filling the interior within the contour of the paving element; and
preferably printing a full-surface cover layer onto the internal structure.

In a first variation, the contour of the paving element is initially printed—preferably after the production of one or more horizontal layers—up to the overall height of the paving element (optionally less the thickness of the cover layer) and the contour is then completely filled, particularly grouted, or provided with the internal structure containing hollow spaces. The cover layer can ultimately be printed, preferably with a higher resolution than the contour.

In a second variation, the contour of the paving element is printed—preferably after the production of one or more horizontal layers—up to a predefined partial height and the interior within the contour is then filled or provided with the internal structure, wherein printing of the contour subsequently continues up to another, higher partial height and the interior being formed within the contour is filled, particularly grouted, or provided with the internal structure up to the higher partial height. This process can be repeated until the overall height of the paving element (optionally less the thickness of a cover layer) is reached. The cover layer can ultimately be printed, preferably with a higher resolution than the contour.

In a third variation, the contour and the internal structure are jointly printed—preferably after the production of one or more horizontal layers—in the form of successive horizontal layers. The cover layer can ultimately be printed.

In a preferred embodiment, the lower layers (i.e. particularly the contours and the fillings or the internal structures) of the paving elements are initially printed with a first, lower resolution and the surfaces (particularly facing layers) of the paving elements (i.e. the visible or exposed surfaces) are subsequently printed with a second, higher resolution. The lower layers preferably amount to more than 70%, particularly more than 80%, preferably about 90%, of the volume of the paving element.

In this embodiment, the surfaces of the paving elements accordingly are printed with a higher resolution than the subjacent layers of the paving elements. The contours (i.e. the lateral peripheries), the fillings (or the internal structures) and the surfaces of the paving elements may in this embodiment respectively comprise the same material or a different material. For example, the contours may therefore be printed with a first material that solidifies quickly, wherein the interior within the contours is then filled with a second material, for example, an insulating material. The upper sides of the filled contours of the paving elements can finally be printed with a decorative high-resolution cover layer that comprises, for example, an image, a logo, a pattern or a company name.

The 3D printing device preferably is positioned and at least one paving element is subsequently produced, wherein the 3D printing device is then repositioned. The repositioning of the 3D printing device preferably takes place by means of control software that may particularly comprise a predefined route. The motion of the 3D printing device may alternatively be controlled in situ, particularly by a user. The preprogrammed route can be changed in real time whenever necessary by means of the control software in dependence on input data from sensors. The new position may also be defined by means of known position finding methods such as laser triangulation, ultrasonic triangulation, tachymeters, GPS, camera(s), 3D cameras, 3D scanners, laser sensors or laser trackers.

In a particularly preferred embodiment, the environment of the surface, particularly the structure of the surface, is surveyed with a sensor before the surface is printed. In a preferred variation, unevenness or level differences on the surface to be printed are compensated in that paving elements with different heights are printed. In another preferred variation, at least one paving element is printed with a height profile, i.e. with different extents in the vertical direction along the paving element. The measured variable of the sensor may be selected from at least one of the parameters hardness, modulus of elasticity, depth, topography, temperature, roughness and moisture of the surface to be printed. The sensor used may be realized in the form of a pressure sensor, an optical sensor (e.g. 3D camera), a laser sensor, an indenter, a perthometer, a temperature sensor, a moisture sensor or an ultrasonic sensor.

In a preferred embodiment, a bedding layer can be dispensed with in that the unevenness of the upper bearing layer is compensated by means of the sensor during the 3D printing process of the paving elements such that the printed paving elements are in full-surface contact with the upper bearing layer.

Consequently, the paving elements particularly can be printed in situ in such a way that one or more bottom layers, which preferably extend essentially horizontally, are initially printed. The contours of the paving elements, i.e. their preferably essentially vertical outer walls, as well as an internal structure within the contours, are subsequently printed.

In a preferred embodiment, the internal structure does not completely fill the contours, but rather leaves open hollow spaces that amount, for example, to at least 10%, preferably at least 20%, of the volume of the paving element. The internal structure preferably forms a pattern such as a honeycomb pattern, a cross pattern, a diagonal pattern, a pattern corresponding to a so-called Hilbert curve or a pattern corresponding to a so-called “archimedean chord”, a concentric pattern or a so-called “octagram spiral” pattern. The shape of the internal structure can also be generated by means of a structure optimization based on a finite element analysis. One or more full-surface cover layer(s), which preferably extend essentially horizontally and form the surface of the paving element, can subsequently be printed onto the internal structure.

In a preferred embodiment, the paving elements are provided with reinforcing elements that preferably comprise at least one of the elements fibers, technical textiles, mats, screens, rods or bars. The reinforcing elements may be produced from various materials such as metal, carbon or plastic.

In a preferred embodiment, temperature sensors are incorporated into the paving elements in order to measure the ground temperature. The temperature sensors can be read out. Among other things, this makes it possible to detect freezing of the pavement surface.

In a preferred embodiment, sensors for determining precipitation amounts and/or seismic data are incorporated into the paving elements.

In another preferred embodiment, heating elements are incorporated into the paving elements. Freezing of the pavement surface can thereby be prevented.

In another preferred embodiment, pressure sensors, e.g. magnetic sensors, are incorporated into the paving elements in order to measure a load exerted upon the paving elements during their use, for example by cars parking or persons standing on the paving elements.

In another preferred embodiment, solar cells or piezoelectric elements are incorporated into the paving elements in order to generate power.

In another preferred embodiment, the paving elements are provided with lighting elements, especially LED elements, particularly on their upper sides, particularly in order to render signals, lights or images.

The invention furthermore proposes a 3D printing device for printing the paving elements onto a surface, particularly onto a bedding layer, in situ in a 3D printing process.

The 3D printing device preferably is designed for producing the bedding layer before the paving elements are printed onto the surface of the bedding layer. The 3D printing device preferably is furthermore designed for producing at least one bearing layer that lies underneath the bedding layer and/or at least one anti-frost layer that lies underneath the bearing layer. In a particularly preferred embodiment, the entire layer structure of the paving area, namely the so-called surfacing, can be produced with the 3D printing device.

The 3D printing device preferably comprises an extruder with an extrusion die, which comprises an outlet opening that preferably can be closed. An exact and loss-free printing process can thereby be advantageously carried out.

In order to produce various types of paving elements, the diameter of the outlet opening of the extrusion die preferably can be adjusted between 0.01 cm and 20 cm, particularly between 0.1 cm and 1 cm. The variable diameter of the outlet opening makes it possible to produce rough contours or large-surface fillings of paving elements on the one hand and to incorporate precise high-resolution structures into the paving element on the other hand without having to exchange the extrusion die before. Narrow areas such as gaps particularly can also be precisely filled with a small or narrow outlet opening.

In order to produce the printable material in situ, it is advantageous that the 3D printing device comprises at least one supply line for dry material and one supply line for water. The printable material preferably is mixed in a mixing chamber within the 3D printing device and is subsequently available for processing. The printable material, from which the paving elements are produced, can thereby be mixed together directly in the 3D printing device. In this way, the composition of the paving elements can be advantageously adjusted and varied in situ.

In a preferred design variation, the 3D printing device, preferably the extrusion die, comprises a supply line for dyes and/or additives. This makes it possible to incorporate decorative patterns into the paving element on the one hand or to realize special chemical or physical properties by means of the additives on the other hand. For example, fluorescent additives may be incorporated into the paving element in order to produce a fluorescent paving element.

In order to allow the most precise printing process possible, the 3D printing device comprises in a preferred embodiment a pivotable robotic arm, wherein the extrusion die preferably is arranged on one end of the robotic arm in a pivotable manner. The robotic arm is preferably controlled by means of the control software. The motion of the robotic arm may also be preprogrammed. Consequently, a certain pattern or a certain shape of the paving element can be preprogrammed, wherein the robotic arm can print this shape in an automated manner by controlling the extruder accordingly.

The 3D printing device preferably comprises at least one sensor for surveying the structure of the surface to be printed and preferably also boundary conditions such as dimensions of the surface to be printed, installations and edgings. The thusly acquired data can be processed by the control of the 3D printing device.

In a preferred embodiment, the 3D printing device comprises a mobile substructure. The motion of the mobile substructure preferably is controlled with control software. In this way, the position of the 3D printing device on the surface to be printed can be preprogrammed such that the 3D printing device can carry out the printing process in an essentially fully automated manner. In order to improve the self-driving properties of the 3D printing device, it is furthermore advantageous that the mobile substructure has additional sensors such as a GPS sensor, a laser sensor, an ultrasonic sensor, a tachymeter, an inclination sensor, a tactile sensor and/or an optical sensor such as a 2D and/or 3D camera for distance determination and/or position finding purposes.

In order to ensure the most reliable locomotion possible, e.g. on the ground of a construction site, it is advantageous that the mobile substructure comprises a track drive.

In an alternative embodiment, the 3D printing device can be moved along the surface to be printed in essentially horizontal and vertical planes by means of a rail system. The rail system preferably is arranged essentially above the surface to be printed, wherein the 3D printing device preferably is suspended on the rail system.

In another alternative embodiment, the 3D printing device comprises one or more wheels.

For the purposes of this disclosure, location and direction information for the 3D printing device such as “top,” “bottom,” etc. refers to the intended operating state of the 3D printing device while printing paving elements onto the surface.

The invention is described in greater detail below with reference to preferred exemplary embodiments, but is not limited to these exemplary embodiments. In the drawings:

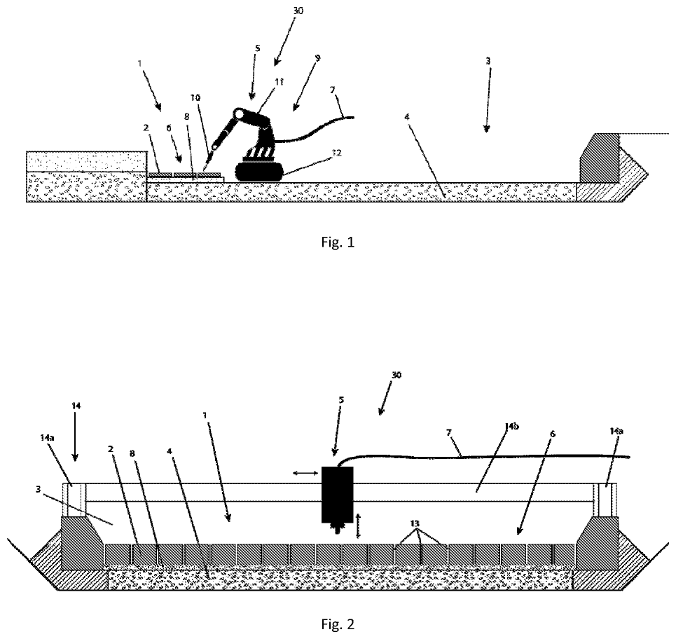

FIG. 1 shows a schematic view of an inventive 3D printing device during the production of a paving area;

FIG. 2 shows a schematic view of an alternative embodiment of the 3D printing device;

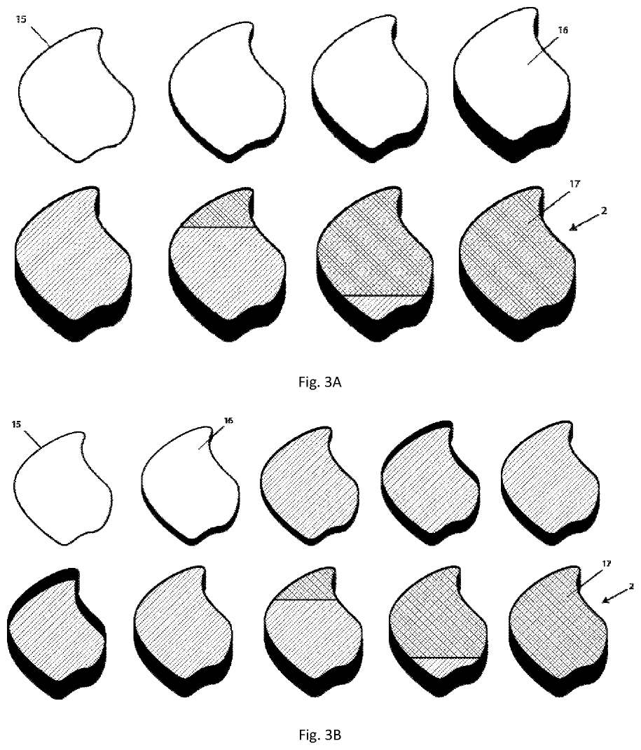

FIG. 3A shows the steps for the production of an individual paving stone according to one design variation;

FIG. 3B shows the steps for the production of an individual paving stone according to another design variation;

FIG. 3C shows the steps for the production of an individual paving stone according to yet another design variation;

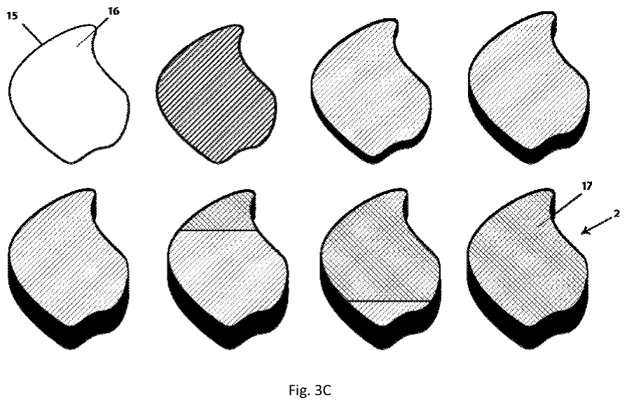

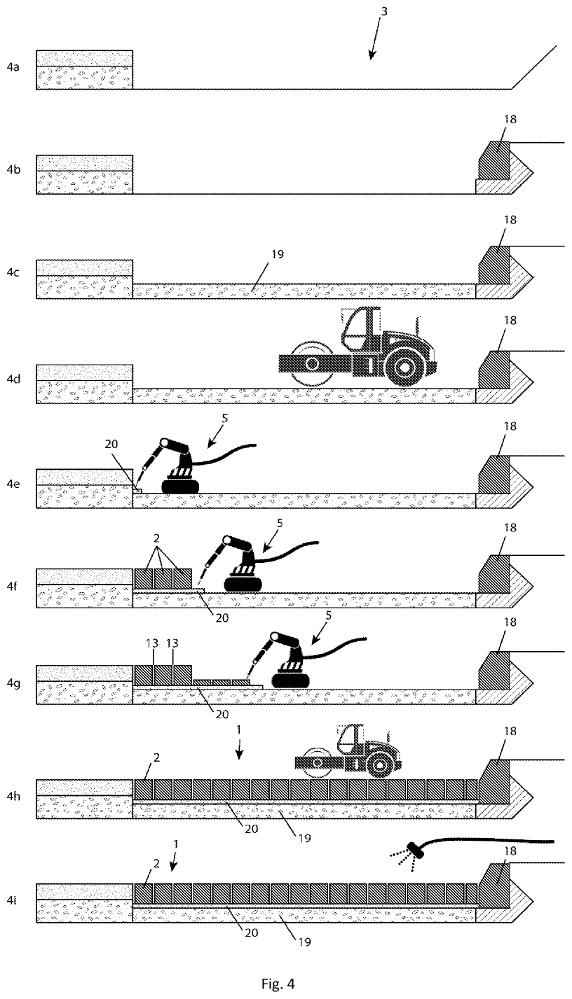

FIGS. 4a-4i show different views of the 3D printing device during the production of the pavement surface;

FIGS. 5a-5e show different embodiments of the mobile 3D printing device;

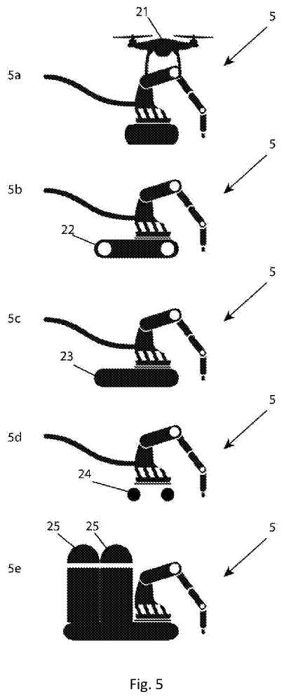

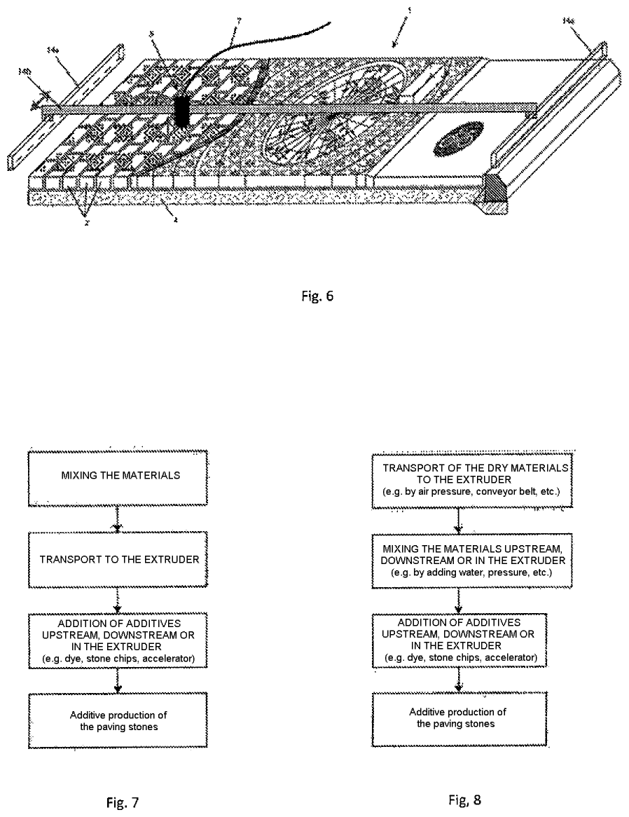

FIG. 6 shows a view of a 3D printing device with a rail system;

FIG. 7 shows a flow chart of a first variation of the production method;

FIG. 8 shows a flow chart of a second variation of the production method;

FIG. 9 shows a schematic view of a first design variation of the 3D printing device with an extruder;

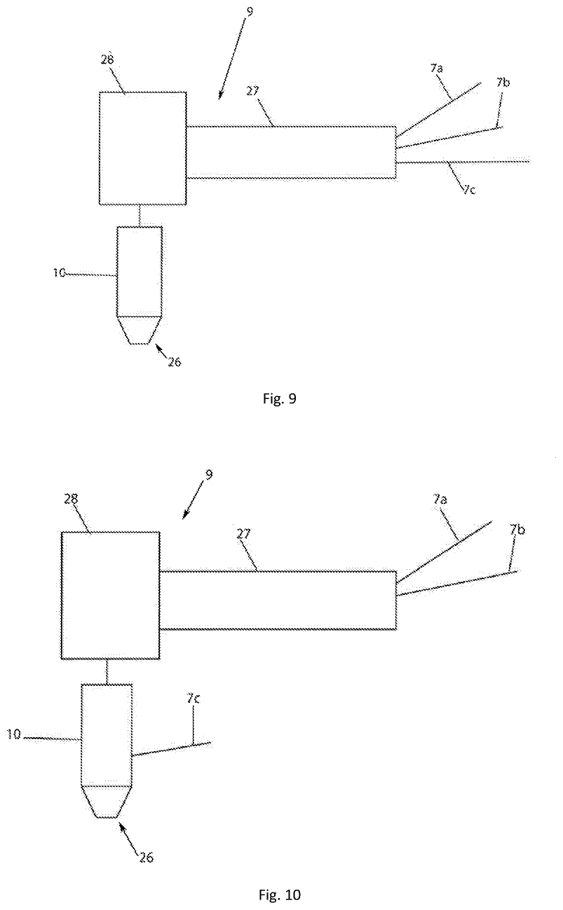

FIG. 10 shows a schematic view of a second design variation of the 3D printing device with an extruder;

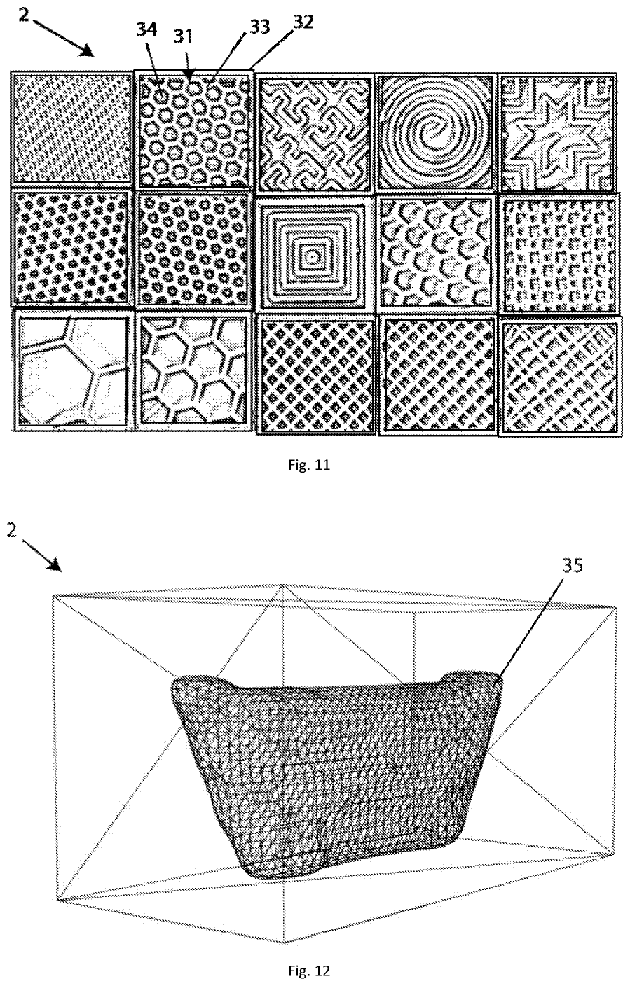

FIG. 11 schematically shows different cross sections of paving stones with an internal structure; and

FIG. 12 schematically shows a model of a paving stone with an internal hollow space, which is obtained by means of topology optimization.

FIG. 1 schematically shows a method for producing a paving area 1 from paving elements, particularly from paving stones 2, by means of 3D printing. A 3D printing device 5 is arranged on an upper bearing layer 3 with a formation 4 and prints the paving stones 2 onto the exposed surface in situ from a printable material 6 in a 3D printing process. The 3D printing device 5 can be moved in all directions on the formation 4. The 3D printing device 5 is supplied with dry material (e.g. cement, sand, aggregates, dye pigments) via a supply line 7. The dry starting materials are mixed with water in order to obtain the printable material 6. The printable material may alternatively be transported to the 3D printing device in a viscous state, particularly by means of an eccentric screw pump. A bearing layer 8 is produced on the formation 4 prior to printing the paving stones 2. The bearing layer 8 preferably is also produced by means of the 3D printing device 5. The paving stones 2 preferably are printed onto the bearing layer 8 in accordance with a preprogrammed route, for example corresponding to a desired pattern. The 3D printing device 5 comprises an extruder 9 with an extrusion die 10, through which the printable material 6 is applied onto the bearing layer 8. The discharge of material from the extrusion die 10 can be stopped. The extrusion die 10 has a variable diameter. In the embodiment shown, the 3D printing device 5 comprises a robotic arm 11, wherein the robotic arm 11 is on one end connected to the mobile substructure of the 3D printing device 5 in an articulated manner. The extrusion die 10 is arranged on the other end of the robotic arm 11. In this way, the extrusion die 10 can be precisely controlled during the printing process.

The 3D printing device 5 accordingly is positioned in the region of the surface to be paved. For example, the 3D printing device may be respectively positioned on a road, a sidewalk or a pedestrian zone, namely on the substructure, on the upper bearing layer, on the anti-frost layer or on the ground or even on building walls. The 3D printing device 5 may also be suspended with cables. The cables may be fastened on existing structures or on specially erected structures.

The paving stones 2 are produced in layers in the form of at least one first layer and one second layer of the printable material 6, wherein the first layers of the paving stones 2 are initially produced prior to the production of the second layers of the paving stones 2. Once printing of a paving stone 2 or a group of paving stones 2 is completed, the 3D printing device 5 is repositioned and a new printing process is started. For this purpose, the 3D printing device 5 comprises a mobile substructure 12, which is realized in the form of a track drive in the exemplary embodiment according to FIG. 1. The control is realized by means of control software. After the paving stones 2 have been printed, the gaps 13 between the paving stones 2 are filled with a grouting material. The gaps can be filled with grouting material by means of the 3D printing device.

FIG. 2 shows an alternative embodiment of the 3D printing device 5, which preferably can be moved horizontally and vertically. A rail system 14 is provided laterally and above the upper bearing layer 3 or the formation 4, wherein the entire surface of the formation 4 is accessible via two transverse rails 14a and a longitudinal rail 14b supported thereon in a sliding manner. The 3D printing device 5 is suspended on the longitudinal rail 14b such that a motion along the surface to be printed can be realized in a horizontal and a vertical plane. The supply with printable material 6 takes place via the supply line 7, wherein the materials are either mixed prior to being supplied to the 3D printing device 5 or directly in the 3D printing device 5. This is also controlled by means of control software such that the 3D printing device 5 can carry out the printing process in a fully automated and autonomous manner.

FIG. 3A shows the step-by-step printing process of a paving stone 2 according to a first design variation, wherein the contours (outer peripheries) 15 of the paving stones 2 are initially printed—preferably after the production of one or more horizontal layers—and the contours 15 are then completely filled or provided with an internal structure 31 containing hollow spaces (see FIG. 11, FIG. 12), and wherein the surfaces of the paving stones 2 are subsequently printed, preferably with a higher resolution than the contours 15. The contours 15 therefore comprise a layer-like structure, in which multiple identical layers are printed on top of one another. The interior 16 is filled with a filling or provided with the internal structure 31 as soon as the last layer of the contour 15 has been printed. A cover layer 17 is printed after the contour 15 has been filled or provided with the internal structure. The cover layer, as well as the filling, may be produced from a different material than the contour 15. The diameter of the extrusion die 10 can be reduced when the cover layer 17 is printed in order to achieve a higher resolution.

FIG. 3B shows an alternative embodiment of the printing process, in which the contours (outer peripheries) 15 are produced up to a predefined partial height of the paving stone 2, preferably after the production of one or more horizontal layers. The interior 16 is then filled or provided with the internal structure 31. Subsequently, the production of the contours 15 continues up to another, higher partial height of the paving stone 2. The interior 16 is then once again filled or provided with the internal structure 31. The alternating production of the contours 15 and the filling or the internal structure 31 is continued until the required overall height of the paving element 2 (optionally less the thickness of a cover layer 17) is reached. The surface of the thusly produced paving stone 2 preferably is printed with the cover layer 17. This cover layer, as well as the filling, may be produced from a different material than the contour 15. The diameter of the extrusion die 10 can be reduced when the cover layer 17 is printed in order to achieve a higher resolution. This embodiment makes it easier to ensure the stability of the contours 15 during the production of the paving elements.

FIG. 3C shows an alternative embodiment, in which the contours 15 and the internal structure 31 are produced layer-by-layer, preferably after the production of one or more horizontal layers. The cover layer 17 is subsequently printed onto the surface of the paving stone 2. The cover layer 17, as well as the filling, may be produced from a different material than the contour 15. The diameter of the extrusion die 10 can be reduced when the cover layer 17 is printed in order to achieve a higher resolution.

FIGS. 4a-4i show a preferred sequence for the production of the paving area 1, wherein the following steps are carried out successively:

FIG. 4a): optionally excavating the recess 3,

FIG. 4b): optionally setting edging stones 18 in concrete,

FIG. 4c): introducing an unbound or bound upper bearing layer 19,

FIG. 4d): optionally compacting the (unbound) upper bearing layer 19,

FIG. 4e): optionally introducing a bedding layer 20, e.g. a sand bedding or mortar bedding, on top of the compacted unbound or bound upper bearing layer 19,

FIG. 4f): producing the paving stones 2 on the bedding layer 20 or directly on the upper bearing layer 19 in situ in a 3D printing process,

FIG. 4g): introducing a filling into gaps 13 between the paving stones 2,

FIG. 4h): optionally compacting the pavement surface,

FIG. 4i): optionally washing in.

The steps according to FIGS. 4c, 4e, 4f and 4g can be respectively carried out with the 3D printing device 5. This means that essentially the entire layer structure of the paving area 1 is produced with the 3D printing device 5.

FIGS. 5A-5e show different embodiments of the mobile 3D printing device 5. FIG. 5a shows a flying drone 21 for transporting the 3D printing device 5. FIG. 5b shows a substructure with a track drive 22, FIG. 5c shows a substructure with air cushion propulsion 23, FIG. 5d shows a wheeled substructure 24 and FIG. 5e shows a substructure that comprises containers 25 with the dry, liquid or viscous printable materials 6. The appropriate substructure is chosen in dependence on the respective application, wherein the printing process is respectively carried out in a fully automated manner by means of control software.

FIGS. 7 and 8 show flow charts for two variations of the printing method. In the variation according to FIG. 7, the starting materials are mixed in advance, transported to the extruder 9, e.g. via supply lines 7, and blended with additives. The paving stones 2 are subsequently printed. According to FIG. 8, the starting materials are mixed in the extruder 9 itself, wherein the individual starting materials are separately transported to the extruder 9. Printing of the paving stones 2 takes place after the addition of additives.

FIGS. 9 and 10 show highly simplified representations of the extruder 9 of the 3D printing device 5. The extruder 9 has an extrusion die 10 with an outlet opening 26 that can be closed. In addition, the diameter of the outlet opening 26 of the extrusion die 10 can be varied. In this way, different paving stones 2 and patterns can be printed as needed (see FIG. 6).

The extruder 9 has a mixing chamber 27, wherein supply lines 7a, 7b, 7c for different dry or liquid starting materials, which are mixed into the printable material 6, lead into said mixing chamber. In the embodiment shown, the extruder 9 furthermore comprises a deceleration chamber 28, from which the printable material 6 is conveyed into the extrusion die 10. The extrusion die 10 applies the printable material 6 onto the surface to be printed in accordance with the specifications of the control software.

In the embodiment according to FIG. 10, a supply line 7c for additives is directly connected to the extrusion die 10. In this way, the additives, e.g. dye pigments, can be supplied separately from the printable base material.

FIG. 11 shows different design variations of paving stones 2 with an internal structure 31 within the outer contours 32. The internal structure 31 comprises internal walls 33 that separate hollow spaces 34 from one another.

FIG. 12 shows an embodiment of a paving stone 2 with an internal hollow space 35 that was calculated by means of topology optimization.

1. A method for producing a paving area (1) from paving elements, particularly from paving stones (2) or paving slabs, characterized in that the paving elements are printed onto a surface in situ from a printable material (6) in a 3D printing process using a 3D printing device (5).

2. The method according to claim 1, characterized in that the 3D printing device (5) comprises an extruder (9), through which the printable material (6) is applied onto the surface.

3. The method according to claim 1 or 2, characterized in that the paving elements are respectively produced by forming at least one first layer and one second layer of the printable material (6).

4. The method according to claim 3, characterized in that the first layers of the paving elements are initially produced prior to the production of the second layers of the paving elements.

5. The method according to one of claims 1 to 4, characterized in that the cover layers (17) of the paving elements are printed with a higher resolution than the subjacent layers.

6. The method according to one of claims 1 to 5, characterized in that the paving elements are printed with an internal structure (31) containing hollow spaces.

7. The method according to claim 6, characterized in that the internal structure (31) is printed onto at least one full-surface bottom layer.

8. The method according to one of claims 1 to 7, characterized in that the paving elements are provided with reinforcing elements.

9. The method according to one of claims 1 to 8, characterized in that temperature sensors, precipitation sensors and/or acceleration sensors are incorporated into the paving elements.

10. The method according to one of claims 1 to 9, characterized in that heating elements are incorporated into the paving elements.

11. The method according to one of claims 1 to 10, characterized in that pressure sensors are incorporated into the paving elements in order to detect a load exerted upon the paving elements.

12. The method according to one of claims 1 to 11, characterized in that solar cells or piezoelectric elements are incorporated into the paving elements in order to generate power.

13. The method according to one of claims 1 to 12, characterized in that the paving elements are provided with lighting elements, especially LED elements and particularly on their upper sides.

14. The method according to one of claims 1 to 13, characterized in that a bedding layer (4a), onto which the printable material (6) is printed, is produced by means of the 3D printing device (5), particularly from at least one of the materials stone chips, sand or mortar.

15. The method according to one of claims 1 to 14, characterized in that the environment of the surface, particularly the structure of the surface, is surveyed with a sensor (29) before the surface is printed.

16. A device (30) for producing a paving area (1) from paving elements, particularly from paving stones (2) or paving slabs, characterized by a 3D printing device (5) for printing the paving elements onto a surface in situ in a 3D printing process.

17. The device (30) according to claim 16, characterized in that the 3D printing device (5) comprises an extruder (9) with an extrusion die (10), which comprises an outlet opening (26) that preferably can be closed.

18. The device (30) according to claim 17, characterized in that the diameter of the outlet opening (26) of the extrusion die (10) preferably can be adjusted between 0.01 and 20 cm, particularly between 0.1 and 1 cm.

19. The device (30) according to one of claims 16 to 18, characterized in that the 3D printing device (5) comprises at least one supply line (7; 7a, 7b, 7c) for dry material and one supply line (7; 7a, 7b, 7c) for water.

20. The device (30) according to one of claims 16 to 19, characterized in that the 3D printing device (5), preferably the extrusion die (10), comprises a supply line (7; 7a, 7b, 7c) for dyes and/or additives.

21. The device (30) according to one of claims 16 to 20, characterized in that the 3D printing device (5) comprises a pivotable robotic arm (11), wherein the extrusion die (10) preferably is arranged on one end of the robotic arm (11) in a pivotable manner.

22. The device (30) according to one of claims 16 to 21, characterized in that the 3D printing device (5) comprises at least one sensor (29), by means of which the structure of the surface to be printed can be surveyed.

23. The device (30) according to one of claims 16 to 22, characterized in that the 3D printing device comprises a mobile substructure (23).
